(19) United States
(12) Patent Application Publication
(10) Pub. No.: US 2012/0167799 A1
(43) Pub. Date: Jul. 5, 2012

(54) DIELECTRIC PASTE COMPOSITION, METHOD OF FORMING TRANSPARENT DIELECTRIC LAYER, TRANSPARENT DIELECTRIC LAYER, AND DEVICE INCLUDING THE TRANSPARENT DIELECTRIC LAYER

(75) Inventors: Min-jong BAE, Yongin-si (KR); Shang-hyeun PARK, Yongin-si (KR); Tae-won JEONG, Yongin-si (KR)

(73) Assignee: SAMSUNG ELECTRONICS CO., LTD., Suwon-si (KR)

(21) Appl. No.: 13/184,243

(22) Filed: Jul. 15, 2011

(30) Foreign Application Priority Data
Jan. 3, 2011 (KR) 10-2011-0000119

(51) Int. Cl. C09D 105/00; B05D 5/12; C08K 5/109

(52) U.S. Cl. 106/217.7; 524/280; 427/77

(57) ABSTRACT

A dielectric paste composition for manufacturing a transparent dielectric layer, the dielectric paste composition including a cyanoresin, and a carbonate solvent. Also a method of forming a transparent dielectric layer, and a device including the transparent dielectric layer.

### CROSS-REFERENCE TO RELATED APPLICATIONS

This application claims priority to Korean Patent Application No. 10-2011-0000119, filed on Jan. 3, 2011, and all the benefits accruing therefrom under 35 U.S.C. §119, the content of which in its entirety is herein incorporated by reference.

### BACKGROUND

1. Field

The present disclosure relates to a dielectric paste composition, methods of forming a transparent dielectric layer, a transparent dielectric layer, and a device including the transparent dielectric layer.

2. Description of the Related Art

High dielectric constant (“high-K”) dielectric layers are widely used as interlayer dielectric layers of film condensers or capacitors in electrical devices, communication devices, power devices, and inverters. High-K dielectric layers are also used as dielectric layers in piezoelectric elements and pyroelectric elements. High-K dielectric layers are also used for supporting transfer bodies. In a powder electroluminescent (a powder “EL”) structure or a thick dielectric electroluminescent (“TDEL”) structure, a dielectric layer is disposed adjacent to an emission layer in a display device, thereby contributing to an increase in a brightness of the emission layer.

A high-K dielectric layer may be formed by melt-kneading or coating, both of which are known to one skilled in the art and can be performed without undue experimentation.

In the melt-kneading method, a polymer and inorganic dielectric particles are kneaded together at a temperature higher than a melting point of the polymer, and the resulting mixture is formed as a film by melt-extrusion or film blowing. Melt-kneading is disclosed in Japanese Patent Laid-Open Publication Nos. 2000-501549 and 2000-294447, the contents of which in their entirety are herein incorporated by reference. However, it is difficult to form a thin film dielectric layer having a sufficiently small number of pores using the melt-kneading method.

The coating method includes printing or coating a dielectric paste composition including high-k inorganic dielectric particles, a binder, and a solvent on a substrate to form a dielectric layer. When a dielectric layer is prepared by such a coating method, the dielectric layer may have an improved dielectric constant by increasing an amount of the inorganic dielectric particles included in the dielectric layer. However, when a concentration of the inorganic dielectric particles in the dielectric paste composition is excessively high, the viscosity of the dielectric paste composition increases, and thus it is difficult to print or coat the composition and the resulting dielectric layer is undesirably thick. To address these and other problems, a method of increasing a dielectric constant by increasing a packing factor by using at least two types of inorganic dielectric particles having different sizes, and a method of preventing loss of a dielectric constant by preventing formation of pores by using a solvent having a boiling point of 160° C. or higher, have been proposed. See, for example, Korean Patent Publication No. 2006-0002844, the content of which in its entirety is herein incorporated by reference. In addition, to improve the dispersion and coating properties of the inorganic dielectric particles in a dielectric paste composition, additives such as a dispersant, an antifoaming agent, a leveling agent and/or an antioxidant may be used. See, for example, Korean Patent Publication No. 2005-0049789, the content of which in its entirety is herein incorporated by reference. Moreover, to form a dielectric layer with excellent surface properties, a leveling agent, a plasticizer and/or an adhesive is used. See, for example, Korean Patent No. 0718923, the content of which in its entirety is herein incorporated by reference. Also, the inorganic dielectric particles may be surface-treated or a dispersant, a surfactant and/or a coupling agent may be added. See, for example, Korean Patent Publication No. 2008-0041711, the content of which in its entirety is herein incorporated by reference.

There nonetheless remains a need for an improved transparent dielectric layer, and a composition for forming the transparent dielectric layer.

### SUMMARY

Provided is a dielectric paste composition including a cyanoresin, propylene carbonate, and optionally a halogenated hydrocarbon.

Provided is a method of forming a transparent dielectric layer using the dielectric paste composition.

Provided is a transparent dielectric layer prepared from the dielectric paste composition.

Provided is a device including the transparent dielectric layer.

Additional aspects, features, and advantages will be set forth in part in the description which follows and, in part, will be apparent from the description.

According to an aspect, disclosed is a dielectric paste composition for manufacturing a transparent dielectric layer, the dielectric paste composition including: a cyanoresin; and a carbonate solvent.

The cyanoresin may include cyanoethyl pullulan, cyanoethyl poly(vinyl alcohol), a copolymer of cyanoethyl pullulan and cyanoethyl poly(vinyl alcohol), cyanoethyl sucrose, or a combination including at least one of the foregoing.

A weight ratio of propylene carbonate to the cyanoresin may be about 95:5 to about 60:40.

The cyanoresin may be at least partially dissolved in the carbonate solvent.

The dielectric paste composition may further include a halogenated hydrocarbon.

The cyanoresin and halogenated hydrocarbon may be at least partially dissolved in the carbonate solvent.

The halogenated hydrocarbon may include chloroform, dichloromethane, dichloroethane, dichloroethylene, trichloroethylene, tetrachloromethane, chlorobenzene, dichlorobenzene, trichlorobenzene, trichlorofluoromethane, trichlorotrifluoroethane, dibromomethane, bromoform, bromochloromethane, methyliodide, polyvinylchloride, poly(4-chlorostyrene), poly(4-bromostyrene), polychlorotrifluoroethylene, polytetrafluoroethylenepropylene, polytetrafluoroethylene, a perfluoroalkoxy compound, poly(2-chloro-1,3-butadiene), or a combination including at least one of the foregoing.

The halogenated hydrocarbon may be included in an amount of about 0.01 to about 15 parts by weight, based on 100 parts by weight of the dielectric paste composition.

According to another aspect, disclosed is a method of preparing a transparent dielectric layer. The method includes: disposing on a substrate a dielectric paste composition including a cyanoresin, and a carbonate solvent; and drying the dielectric paste composition to prepare the transparent dielectric layer.

The drying may be performed at a temperature of about 50 to about 160° C.

The dielectric paste composition may not be subjected to a sintering process.

According to another aspect, a transparent dielectric layer includes: a product of a composition including a cyanoresin; and a carbonate solvent.

The composition may further include a halogenated hydrocarbon.

The transparent dielectric layer may be flexible.

According to another aspect, disclosed is a device including the transparent dielectric layer.

The device may be an inorganic electroluminescent device, a film condenser, a capacitor, a piezoelectric element, a pyroelectric element, or a flexible display.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view of an embodiment of an inorganic electroluminescent device;

FIG. 2 is a cross-sectional view of another embodiment of an inorganic electroluminescent device;

FIG. 3 is a graph of brightness (candelas per square meter, cd/m²) versus driving voltage (Volts, V) showing brightness and driving (e.g., withstanding) voltage properties of an inorganic electroluminescent device prepared according to Example 2A;

FIG. 4 is a graph of brightness (candelas per square meter, cd/m²) versus driving voltage (Volts, V) showing brightness and driving voltage properties of an inorganic electroluminescent device prepared according to Comparative Example 2A; and

FIG. 5 is a graph of brightness (candelas per square meter, cd/m²) versus driving voltage (Volts, V) showing brightness and driving voltage properties of an inorganic electroluminescent device prepared according to Comparative Example 2B.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Hydrocarbon” means an organic compound having at least one carbon atom and at least one hydrogen atom, optionally substituted with one or more substituents where indicated.

“Alkyl” means a straight or branched chain saturated aliphatic hydrocarbon having the specified number of carbon atoms, specifically 1 to 12 carbon atoms, more specifically 1 to 6 carbon atoms (e.g., methyl or hexyl).

“Alkylene” means a straight, branched or cyclic divalent aliphatic hydrocarbon group, and may have from 1 to about 18 carbon atoms, specifically 2 to about 12 carbons (e.g., methylene (—CH₂—) or, propylene (—(CH₂)₃—)).

“Alkoxy” means an alkyl group that is linked via an oxygen (i.e., —O-alkyl), and may have from 1 to 30 carbon atoms, specifically 2 to 20 carbon atoms. Nonlimiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups.

Transparent as used herein refers to a transparency of a dielectric layer.

An embodiment of a dielectric paste composition will now be disclosed further detail.

The dielectric paste composition includes a cyanoresin and a carbonate solvent.

The cyanoresin is used to provide a high dielectric constant to the dielectric paste composition. The cyanoresin may comprise a cyano-substituted polysaccharide, a cyano-substituted poly(vinyl alcohol), or copolymer comprising at least one of the foregoing. The polysaccharide may be a pullulan.

The cyanoresin may comprise cyanoethyl pullulan, cyanoethyl poly(vinyl alcohol), a copolymer of cyanoethyl pullulan and cyanoethyl poly(vinyl alcohol), cyanoethyl sucrose, or a combination comprising at least one of the foregoing.

The carbonate solvent may be a suitable solvent for dissolving the cyanoresin. A transparent dielectric layer having a high dielectric constant, a low leakage current, and a high driving voltage may be formed from the dielectric paste composition including the carbonate solvent.

The carbonate solvent is selected to have a vapor pressure sufficiently low so that the carbonate solvent is removed by evaporation at a temperature about 20 to about 160° C., specifically about 120 to 140° C., more specifically about 130° C., at atmospheric pressure.

The carbonate solvent may be an aliphatic carbonate, an aromatic carbonate, or an aliphatic-aromatic carbonate. A combination comprising at least one of the foregoing can be used.

The aliphatic carbonate may be a chain carbonate or a cyclic carbonate, and may be an alkylene carbonate, a dialkyl carbonate, or a combination comprising at least one of the foregoing. The aliphatic carbonate may comprise 1 to about 8 carbon atoms, specifically 1 to about 5 carbon atoms, more specifically 1 to about 4 carbon atoms.

The aliphatic carbonate may comprise dimethyl carbonate, ethyl methyl carbonate, diethyl carbonate, methyl-n-propyl carbonate, ethyl-n-propyl carbonate, di-n-propyl carbonate, ethylene carbonate, propylene carbonate, 2-ethylethylene carbonate, 2,3-dimethylethylene carbonate, or vinylethylene carbonate. A combination comprising at least one of the foregoing can be used. In an embodiment the aliphatic carbonate is propylene carbonate.

A representative aromatic carbonate includes diphenyl carbonate. Representative aliphatic-aromatic carbonates include methyl phenyl carbonate, ethyl phenyl carbonate, and butyl phenyl carbonate, for example.

In an embodiment, the carbonate solvent further comprises water, and the carbonate solvent may be an aqueous solution of the aliphatic carbonate. Also, the carbonate solvent may further comprise other solvents with the proviso that the other solvent does not adversely affect the transparent properties of the dielectric layer manufactured with the paste composition.

In the dielectric paste composition, the cyanoresin may be at least partially dissolved in the carbonate solvent.

A weight ratio of the propylene carbonate to the cyanoresin may be about 95:5 to about 60:40, for example, from about 90:10 to about 60:40, in detail, about 82:18. When the weight ratio is within the foregoing range, a transparent dielectric layer may be formed having a high dielectric constant, a low dielectric loss, and a high breakdown voltage.

The dielectric paste composition may further include a halogenated hydrocarbon. The halogenated hydrocarbon may increase a dielectric constant of a transparent dielectric layer prepared using the dielectric paste composition. Also, the cyanoresin and the halogenated hydrocarbon may be at least partially dissolved in the carbonate solvent.

The halogenated hydrocarbon may include a low molecular weight compound and/or a polymer compound, each including a halogen element such as fluorine, chlorine, bromine, iodine, or astatine. The halogenated hydrocarbon may include a low molecular weight compound, for example, a compound having a molecular weight of about 34 to about 250 Daltons, specifically about 40 to about 200 Daltons. The halogenated hydrocarbon may be liquid at room temperature, which allows the halogenated hydrocarbon to be sufficiently mixed with the other components of the dielectric paste composition, and which may be sufficiently dispersed in the dielectric paste composition. Also, the halogenated hydrocarbon may include a higher molecular weight compound, which as used herein may include an oligomer. For example, the halogenated hydrocarbon may include a compound having a molecular weight of greater than about 250 to about 600 Daltons, specifically about 300 to about 550 Daltons, more specifically about 350 to about 500 Daltons. The halogenated hydrocarbon may include a polymer, which may be included in the form of a powder, so as to increase the stability of the dielectric paste composition after a drying process. The polymer may have, for example, a number average molecular weight of about 250 to about 1,000,000 Daltons, specifically about 500 to about 500,000 Daltons, more specifically about 1,000 to about 100,000 Daltons.

The halogenated hydrocarbon may be chloroform, dichloromethane, dichloroethane, dichloroethylene, trichloroethylene, tetrachloromethane, chlorobenzene, dichlorobenzene, trichlorobenzene, trichlorofluoromethane, trichlorotrifluoroethane, dibromomethane, bromoform, bromochloromethane, methyliodide, polyvinylchloride, poly(4-chlorostyrene), poly(4-bromostyrene), polychlorotrifluoroethylene, polytetrafluoroethylenepropylene, polytetrafluoroethylene, a perfluoroalkoxy compound, poly(2-chloro-1,3-butadiene), but is not limited thereto. A combination comprising at least one of the foregoing can be used.

The halogenated hydrocarbon may be included in an amount of about 0.01 to about 15 parts by weight, based on 100 parts by weight of the dielectric paste composition. When the amount of the halogenated hydrocarbon is within this range, a significant increase in the dielectric constant may be obtained, and the miscibility of the halogenated hydrocarbon in the dielectric paste composition may be suitably high, and thus a uniform transparent dielectric layer may be formed.

Hereinafter, a method of preparing a transparent dielectric layer using the dielectric paste composition will be disclosed in further detail.

In an embodiment, a method of preparing a transparent dielectric layer comprises disposing on a substrate a dielectric paste composition comprising a cyanoresin, and a carbonate solvent; and drying the dielectric paste composition to prepare the transparent dielectric layer.

The disposing of the dielectric paste composition on the substrate may comprise printing or coating. The coating process may be performed by spin coating.

The substrate may be appropriately selected according to the use of a transparent dielectric layer to be prepared. For example, the substrate may be a glass substrate, a glass substrate printed or coated with an electrode material, an emission layer, or an electrode.

The drying process may be performed at a temperature of about 50 to about 160° C., for example, from about 120 to 140° C., in detail about 130° C. In the drying process a material such as water may be removed by the drying process. The material may have a vapor pressure sufficiently low so that the material may be removed by evaporation, and the material may have a boiling point lower that the temperature at which the drying process is performed. Thus the material may be removed via evaporation.

In an embodiment of the method, the dielectric paste composition, which may be printed or coated on the substrate, is not subjected to a sintering process, but may be subjected to the drying process at a low temperature, e.g., about 50 to about 160° C., for example, and thus a transparent dielectric layer having excellent flexibility and a high dielectric constant may be obtained. If the sintering process is performed, the cyanoresin included in the dielectric paste composition may be thermally decomposed and discoloured, and thus a transparent dielectric layer may not be obtained.

In an embodiment, the transparent dielectric layer may comprise a product of a composition comprising a cyanoresin; and a carbonate solvent. The composition may further comprise a halogenated hydrocarbon. In an embodiment the transparent dielectric layer may include a product of a composition comprising a cyanoresin, propylene carbonate, and optionally a halogenated hydrocarbon.

In an embodiment, the transparent dielectric layer does not substantially include water. In another embodiment, the transparent dielectric layer does not include water.

Since the composition, structures, effects of the cyanoresin, the carbonate solvent, and the halogenated hydrocarbon are identical to those disclosed above, details thereof will not be repeated herein.

The transparent dielectric layer may have a high dielectric constant, and may have excellent flexibility. The transparent dielectric layer may have a flexural modulus of about 100 to about 2000 megaPascals (MPa), specifically about 200 to about 1500 MPa, more specifically about 300 to about 1000 MPa. While not wanting to be bound by theory, it is believed that the excelled flexibility is because the transparent dielectric layer is not sintered, i.e., a sintering process is not performed while preparing the transparent dielectric layer. Thus in an embodiment neither the dielectric paste composition nor the resulting transparent dielectric layer are sintered.

The transparent dielectric layer may be used in a device such as an inorganic electroluminescent device, a film condenser, a capacitor, a piezoelectric element, a pyroelectric element, or a flexible display such as, for example, e-paper.

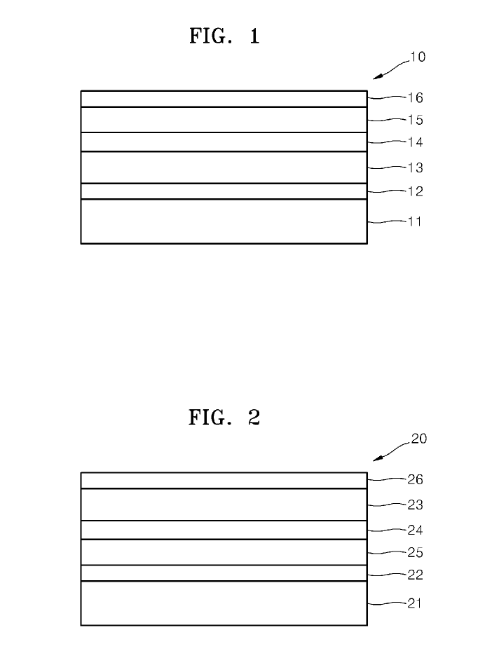

FIGS. 1 and 2 are, respectively, cross-sectional views of first and second inorganic electroluminescent devices 10 and 20, respectively, each comprising a transparent second dielectric layer 15 and 25, respectively. The transparent second dielectric layers 15 and 25 are each prepared using a dielectric paste composition, as disclosed above.

Referring to FIG. 1, the inorganic electroluminescent device 10 includes a substrate 11, a first electrode 12, a first dielectric layer 13, an emission layer 14, the second dielectric layer 15, and a second electrode 16.

The substrate 11 may comprise a transparent material such as a glass.

The first electrode 12 may be a transparent electrode, such as an indium tin oxide (“ITO”) electrode.

The first dielectric layer 13 may be formed by disposing (e.g., printing or coating) a dielectric paste composition on the first electrode 12, drying the dielectric paste composition, and optionally sintering the dried dielectric paste composition. The dielectric paste composition used to prepare the first dielectric layer 13 may be different from the dielectric paste composition disclosed above. In other words, the dielectric paste composition used to prepare the first dielectric layer 13 may include a binder such as fluororubber or a cyanoresin, an inorganic dielectric particle such as barium titanate, a solvent such as dimethylformamide, and optionally a halogenated hydrocarbon as an additive.

The emission layer 14 generates light when a voltage is applied between the first electrode 12 and the second electrode 16. The emission layer 14 may comprise a phosphor such as zinc sulphide (ZnS), a binder such as a cyanoresin, and a solvent such as dimethylformamide.

The second dielectric layer 15 may be formed by disposing (e.g., printing or coating) the dielectric paste composition disclosed above on the emission layer 14, and drying the dielectric paste composition.

The second electrode 16 may be a transparent electrode comprising ITO. The light generated in the emission layer 14 may be externally emitted through the second electrode 16.

In the inorganic electroluminescent device 10, a brightness of the light generated by the emission layer 14 and externally emitted through the second electrode 16 when the voltage is applied between the first and second electrodes 12 and 16 may be increased due to a high dielectric constant of the first and second dielectric layers 13 and 15, respectively, and a driving voltage of the inorganic electroluminescent device 10 may be increased.

Referring to FIG. 2, the inorganic electroluminescent device 20 includes a substrate 21, a first electrode 22, the second dielectric layer 25, an emission layer 24, a first dielectric layer 23, and a second electrode 26. The first electrode 22 may be a transparent electrode comprising ITO, and the second electrode 26 may be an opaque electrode comprising aluminium.

The structure of the inorganic electroluminescent device 20 of FIG. 2 is different from the structure of the inorganic electroluminescent device 10 of FIG. 1 in that the second electrode 26 may be opaque, a stacking order of the first dielectric layer 23, the emission layer 24, and the second dielectric layer 25 is a reverse of a stacking order in the inorganic electroluminescent device 10, and light generated by the emission layer 24 is externally emitted through the substrate 21.

An embodiment will now be disclosed more fully with the following examples. These examples are for illustrative purposes only.

### EXAMPLES

### Examples 1A and 1B and Comparative Example 1

### Preparation of Dielectric Paste Composition and Dielectric Layer

Cyanoethyl pullulan (Shin-Etsu, CRS), a solvent, and chlorobenzene (“CB”) were mixed in the ratios shown in Table 1 below, and each mixture was stirred for 2 hours to form a dielectric paste composition. Then, each dielectric paste composition was spin-coated at 2000 revolutions per minute (“rpm”) on a glass substrate coated with ITO (JMC, ITO glass 1.8T Soda Lime), and dried at 130° C. for 30 minutes to form a dielectric layer. Next, an aluminum electrode was formed on the dielectric layer. The aluminum electrode was formed by sputter depositing with a direct current (“DC”) power of 80 Watts (“W”), wherein a thickness of the formed aluminum electrode was 200 nanometers (nm). Then, a voltage of 0.1 Volts (“V”) was applied to the dielectric layer via the ITO and aluminum layer at room temperature by varying a frequency from 10 Hertz (Hz) to 1 megaHertz (MHz), and a dielectric constant and dielectric loss of the dielectric layer were measured using an Inductance-Capacitance-Resistance (“LCR”) meter (AGILENT, E4980A). The dielectric constant, the dielectric loss, and breakdown voltage per unit thickness of layer measured at 1 kHz are shown in Table 2 below.

TABLE 1

| | CRS (Parts by | Solvent (Parts by Weight) | | CB (Parts by |
|---|---|---|---|---|
| | Weight) | PC*¹ | DMF*² | Weight) |
| Comparative | 18 | 0 | 82 | 0 |
| Example 1 | | | | |
| Example 1A | 18 | 82 | 0 | 0 |
| Example 1B | 18 | 82 | 0 | 12 |

*¹Propylene Carbonate
*²Dimethylformamide

TABLE 2

| | | | Breakdown Voltage per |
|---|---|---|---|
| | Relative Dielectric | Dielectric | Unit Thickness of |
| | Constant | Loss | Layer (V/μm) |
| Comparative | 18.71 | 0.035 | 94 |
| Example 1 | | | |
| Example 1A | 27.57 | 0.020 | 140 |
| Example 1B | 28.15 | 0.018 | 140 |

V/μm refers to Volts per micrometer

Referring to Table. 2, the dielectric layer prepared according to Examples 1A and 1B have a higher dielectric constant, a higher breakdown voltage per unit thickness of layer, and lower dielectric loss than the dielectric layer prepared according to Comparative Example 1. As dielectric loss decreases, a leakage current decreases.

### Example 2A

### Manufacture of Inorganic Electroluminescent Device

An inorganic electroluminescent device having the structure shown in FIG. 1 was manufactured as follows.

### Preparation Example 1: Preparation of Substrate, First Electrode, and First Dielectric Layer

A quantity of 11 parts by weight of cyanoethyl pullulan (Shin-Etsh, “CRS”) and 51 parts by weight of dimethylformamide (“DMF”) were mixed together, and the mixture was stirred for 2 hours to prepare a binder solution. Next, 38 parts by weight of barium titanate (Samsung Fine Chemistry, SBT-03) was further added to the binder solution to prepare an undispersed dielectric paste composition. Thereafter, zirconia beads (diameter=5 millimeters (mm)) were added to the dielectric paste composition in the same volume as that of the dielectric paste composition, and the resulting mixture was ball-milled for 72 hours to prepare a dispersed dielectric paste composition. Next, the dispersed dielectric paste composition was spin coated at 3000 rpm on a glass substrate coated with ITO (JMC, ITO glass 1.8T Soda Lime), and the resulting structure was dried at 130° C. for 30 minutes to form a first dielectric layer.

### Preparation Example 2

### Preparation of Emission Layer

A quantity of 15 parts by weight of a copolymer (Shin-Etsu, CRM) of cyanoethyl pullulan and cyanoethyl poly(vinylalcohol) and 60 parts by weight of DMF were mixed together, and the mixture was stirred for 2 hours to prepare a binder solution. Subsequently, 25 parts by weight of ZnS doped with Mn (Mitsubishi Chemical, KX-605A) was added to the binder solution and mixed together to prepare an undispersed phosphor paste composition. Thereafter, zirconia beads (diameter=5 mm) were added to the phosphor paste composition in the same volume as that of the phosphor paste composition, and the resulting mixture was ball-milled for 72 hours to prepare a dispersed phosphor paste composition. Subsequently, the dispersed phosphor paste composition was spin coated at 800 rpm on the first dielectric layer prepared according to Preparation Example 1, and the resulting structure was dried at 130° C. for 30 minutes to form an emission layer.

### Preparation Example 3

### Preparation of Second Dielectric Layer

The dielectric paste composition prepared according to Example 1A was spin-coated at 2000 rpm on the emission layer prepared in Preparation Example 2, and then dried at 130° C. for 30 minutes to form a second dielectric layer.

### Preparation Example 4

### Preparation of Second Electrode

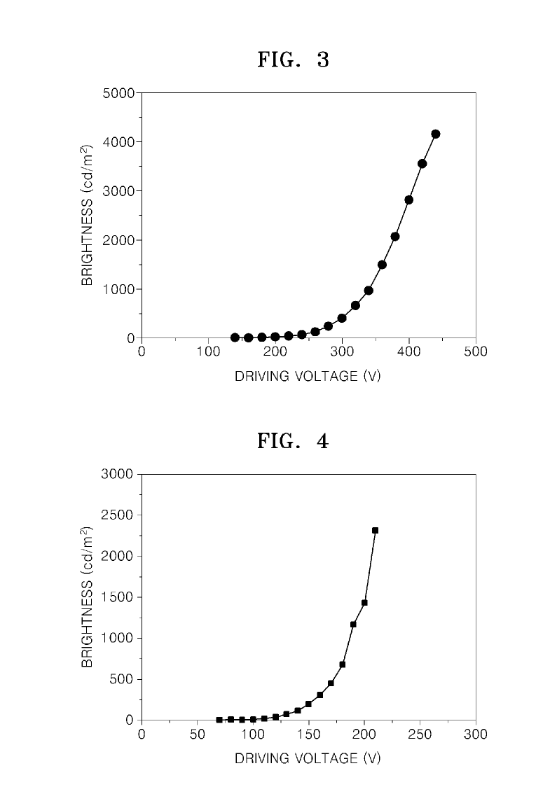

An inorganic electroluminescent device was obtained by forming an ITO electrode on the second dielectric layer prepared according to Preparation Example 3. Here, the ITO electrode was formed by sputter depositing with a DC power of 80 W, and a thickness of the formed ITO electrode was 200 nm. Then, the brightness of the manufactured inorganic electroluminescent device was measured using a brightness measuring device (BM-7, Topcon) by varying a driving voltage of the inorganic electroluminescent device from 0 V to 450 V, and the results are illustrated in FIG. 3.

### Comparative Example 2A

### Manufacture of Inorganic Electroluminescent Device

An inorganic electroluminescent device was manufactured in the same manner as in Example 2A, except that the process of forming a second dielectric layer on an emission layer was not performed, and an ITO electrode was formed directly on the emission layer. Then, the brightness of the manufactured inorganic electroluminescent device was measured using a brightness measuring device (BM-7, Topcon) by varying a driving voltage of the inorganic electroluminescent device from 0 V to 450 V, and the results are illustrated in FIG. 4.

### Comparative Example 2B

### Manufacture of Inorganic Electroluminescent Device

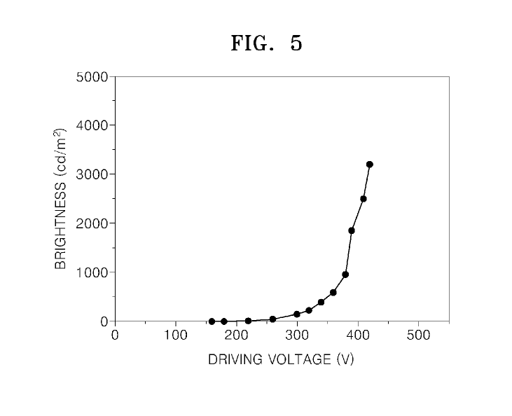

An inorganic electroluminescent device was manufactured in the same manner as in Example 2A, except that the dielectric paste composition of Comparative Example 1 was used instead of the dielectric paste composition of Example 1A to form a second dielectric layer. Then, the brightness of the manufactured inorganic electroluminescent device was measured using a brightness measuring device (BM-7, Topcon) by varying a driving voltage of the inorganic electroluminescent device from 0 V to 450 V, and the results are illustrated in FIG. 5.

Referring to FIGS. 3 through 5, the inorganic electroluminescent device manufactured according to Example 2A has excellent brightness and a high breakdown voltage compared to the inorganic electroluminescent devices manufactured according to Comparative Examples 2A and 2B. A breakdown voltage is a voltage that is a little higher than a driving voltage corresponding to a peak of a curve of brightness. In detail, a breakdown voltage in FIG. 3 is about 440 V, a breakdown voltage in FIG. 4 is about 220 V, and a breakdown voltage in FIG. 5 is about 420 V.

As disclosed above, according to an embodiment, a dielectric paste composition can be provided by combining a cyanoresin, a carbonate solvent, and optionally a halogenated hydrocarbon. A transparent dielectric layer produced using the dielectric paste composition provides an improved dielectric constant.

Also, a method of preparing a transparent dielectric layer, which includes a low temperature drying process and does not include a sintering process, wherein the low temperature drying process may be performed after a printing or coating process, may comprise disposing the dielectric paste composition.

In addition, a transparent dielectric layer, which has a high dielectric constant, a low leakage current, i.e., low dielectric loss, a high driving (e.g., withstanding) voltage, i.e., a high breakdown voltage, and high flexibility, may be provided using the dielectric paste composition.

Further, a device having improved brightness, an improved driving voltage, and in an embodiment improved flexibility may be provided by including the transparent dielectric layer.

It should be understood that the exemplary embodiments disclosed herein should be considered in a descriptive sense only and not for purposes of limitation. Descriptions of features, advantages, or aspects of each embodiment shall be considered as available for other similar features, advantages, or aspects of other embodiments.

What is claimed is:

1. A dielectric paste composition for manufacturing a transparent dielectric layer, the dielectric paste composition comprising:
a cyanoresin; and
a carbonate solvent.

2. The dielectric paste composition of claim 1, wherein cyanoresin is a cyano-substituted polysaccharide, a cyano-substituted poly(vinyl alcohol), or copolymer comprising at least one of the foregoing.

3. The dielectric paste composition of claim 2, wherein the cyanoresin comprises cyanoethyl pullulan, cyanoethyl poly(vinyl alcohol), a copolymer of cyanoethyl pullulan and cyanoethyl poly(vinyl alcohol), cyanoethyl sucrose, or a combination comprising at least one of the foregoing.

4. The dielectric paste composition of claim 1, wherein the carbonate solvent comprises an aliphatic carbonate.

5. The dielectric paste composition of claim 4, wherein the aliphatic carbonate comprises dimethyl carbonate, ethyl methyl carbonate, diethyl carbonate, methyl-n-propyl carbonate, ethyl-n-propyl carbonate, di-n-propyl carbonate, ethylene carbonate, propylene carbonate, 2-ethylethylene carbonate, 2,3-dimethylethylene carbonate, vinylethylene carbonate, or a combination comprising at least one of the foregoing.

6. The dielectric paste composition of claim 4, wherein the aliphatic carbonate is propylene carbonate.

7. The dielectric paste composition of claim 1, wherein a weight ratio of the carbonate solvent to the cyanoresin is about 95:5 to about 60:40.

8. The dielectric paste composition of claim 4, wherein a weight ratio of the carbonate to the cyanoresin is about 95:5 to about 60:40.

9. The dielectric paste composition of claim 1, wherein the carbonate solvent further comprises water.

10. The dielectric paste composition of claim 1, wherein the cyanoresin is at least partially dissolved in the carbonate solvent.

11. The dielectric paste composition of claim 1, further comprising a halogenated hydrocarbon.

12. The dielectric paste composition of claim 11, wherein the cyanoresin and the halogenated hydrocarbon are at least partially dissolved in the carbonate solvent.

13. The dielectric paste composition of claim 11, wherein the halogenated hydrocarbon comprises chloroform, dichloromethane, dichloroethane, dichloroethylene, trichloroethylene, tetrachloromethane, chlorobenzene, dichlorobenzene, trichlorobenzene, trichlorofluoromethane, trichlorotrifluoroethane, dibromomethane, bromoform, bromochloromethane, methyliodide, polyvinylchloride, poly(4-chlorostyrene), poly(4-bromostyrene), polychlorotrifluoroethylene, polytetrafluoroethylenepropylene, polytetrafluoroethylene, a perfluoroalkoxy compound, poly(2-chloro-1,3-butadiene), or a combination comprising at least one of the foregoing.

14. The dielectric paste composition of claim 11, wherein an the halogenated hydrocarbon is included in an amount of about 0.01 to about 15 parts by weight, based on 100 parts by weight of the dielectric paste composition.

15. A method of preparing a transparent dielectric layer, the method comprising:
disposing on a substrate a dielectric paste composition comprising
a cyanoresin, and
a carbonate solvent; and
drying the dielectric paste composition to prepare the transparent dielectric layer.

16. The method of claim 15, wherein the disposing comprises printing or coating.

17. The method of claim 15, wherein the drying is performed at a temperature of about 50 to about 160° C.

18. The method of claim 15, wherein the dielectric paste composition is not subjected to a sintering process.

19. A transparent dielectric layer comprising:
a product of a composition comprising
a cyanoresin; and
a carbonate solvent.

20. The transparent dielectric layer of claim 19, wherein the composition further comprises a halogenated hydrocarbon.

21. The transparent dielectric layer of claim 19, wherein the transparent dielectric layer is flexible.

22. The transparent dielectric layer of claim 21, wherein the transparent dielectric layer has a flexural modulus of about 100 to about 2000 megaPascals.

23. A device comprising the transparent dielectric layer of claim 19.

24. The device of claim 22, being an inorganic electroluminescent device, a film condenser, a capacitor, a piezoelectric element, a pyroelectric element, or a flexible display.
